(19) United States
(12) Patent Application Publication
(10) Pub. No.: US 2018/0177199 A1
(43) Pub. Date: Jun. 28, 2018

(54) SEGMENTED CONVEYOR BELTS FOR FOODSERVICE CONVEYOR OVENS

(71) Applicant: CLEVELAND RANGE, LLC, Cleveland, OH (US)

(72) Inventor: Nelson Douglas PITLOR, Twinsburg, OH (US)

(21) Appl. No.: 15/849,985

(22) Filed: Dec. 21, 2017

Related U.S. Application Data
(60) Provisional application No. 62/438,736, filed on Dec. 23, 2016.

(51) Int. Cl. A21B 1/48; A21B 1/26

(52) U.S. Cl. CPC A21B 1/48; B65G 23/36; A21B 1/26

(57) ABSTRACT

The present disclosure provides a conveyor oven with a heating chamber, and a segmented conveyor belt that passes food products through the chamber for heating or cooking. The conveyor can comprise two or more removably connected sections. One of the sections can be sized so that it can be removed through a front of the heating chamber. The sections can be coupled together with a drive transfer device that transfers any motion from one section to another. The sections can also have motors associated therewith, so that motion of each section can be controlled independently of other sections.

### CROSS-REFERENCE TO RELATED APPLICATION

The present application claims the benefit of U.S. Provisional Application Ser. No. 438,736, filed on Dec. 23, 2016, which is herein incorporated by reference.

### BACKGROUND OF THE DISCLOSURE

### 1. Field of the Disclosure

The present disclosure relates to segmented conveyor belts for ovens or other devices that can be separated for easy removal and maintenance. The belt segments can be removed from the sides and/or front of the oven cavity.

### 2. Description of the Related Art

Typically, in conveyor ovens used in commercial kitchens, a conveyor belt carries food products thereon from one side of the oven to the other, while passing the food products through a heating chamber where they are cooked. Removal, maintenance, and cleaning of the conveyor belts can be challenging, however. Common foodservice conveyor ovens only allow the conveyor belts to be removed from the sides. Since most conventional conveyor belts are one, single piece, this means that there must be at least as much clearance on either side of the oven as the length of the conveyor belt. A typical conveyor belt that is part of a conveyor oven is 40% to 100% longer than the oven itself. For example, a forty-inch wide oven can have a conveyor belt seventy-eight inches long, protruding nineteen inches from each side of the oven. To remove the conveyor belt from the oven, a space no less than seventy-eight inches will be required to one side of the oven, meaning that the overall space required for this oven would be no less than one hundred thirty-seven inches. This is clearly a significant problem and inconvenience for commercial food establishments, where kitchen and food preparation space is at a premium. In addition, current long, single-piece conveyor belts may need two or more people to manage. There is a need to address these disadvantages.

### SUMMARY OF THE DISCLOSURE

The present disclosure provides a conveyor cooking oven with a conveyor belt that can be split up into two or more removably connected sections, preferably three or more removably connected sections. In addition, the oven can have an opening on a front, which allows for the removal of the middle conveyor belt section through the front of the oven, as opposed to out of the side openings. The conveyor belt sections can be connected to one another with a coupling device, which in one embodiment can be a drive transfer device. The side sections of the conveyor belt can also have a gap between them and the center section, which can allow for side doors on the oven to be closed.

Thus, when the conveyor belt in the oven of the present disclosure needs to be removed, serviced, or cleaned, the user can detach the side sections, and remove the middle section through the front of the oven. This allows for much great flexibility and space-saving in the kitchen. The oven only needs minimal clearance over what the oven is given for placement and operation, if any at all.

In one embodiment, the present disclosure provides a conveyor oven comprising a housing defining a heating chamber, a heating element or air duct within the heating chamber, two openings, one on each opposing side of the housing, and a conveyor belt passing through each of the openings and the heating chamber. The conveyor belt comprises two or more sections that are removably connected to one another. The oven may further comprise a front panel removably connected to the housing, wherein one of the conveyor belt sections can be removed from and placed into the heating chamber when the front panel is removed.

For ease of description, the term “conveyor belt” is used in the present specification. The term “conveyor belt” should be understood to signify sheet belts, that can be made of any material suitable for use in high temperature ovens, such as but not limited to, sheet metal, chain metal, metal chain mail or mesh, or spaced apart wire.

In addition, for ease of description, the terms “side” and “front” are used herein. A “side” or “side to side” direction refers to the direction in which the longitudinal axis and direction of travel of a conveyor is oriented. The “front” direction in this instance refers to a direction that is perpendicular to the side to side direction. The “length” of conveyor 20 or its segments are along the left side to right side dimension when looking at the front of the oven.

### BRIEF DESCRIPTION OF THE DRAWINGS

FIG. 1a is a schematic, front perspective view of the oven of the present disclosure.

FIG. 1b is a front view of the oven of FIG. 1a.

FIG. 1c is an enlarged view of a side opening in the oven of FIG. 1b.

FIG. 2a is an exploded perspective view of the oven of the present disclosure.

FIG. 2b is an enlarged view of a drive transfer device from the oven of FIG. 2a.

FIG. 3a is a top view of a segmented conveyor belt of the present disclosure.

FIG. 3b is a top, perspective view of the segmented conveyor belt of FIG. 3a.

FIG. 3c is a front view of the segmented conveyor belt of FIG. 3a.

FIG. 3d is a side view of the segmented conveyor belt of FIG. 3a.

### DETAILED DESCRIPTION OF THE DISCLOSURE

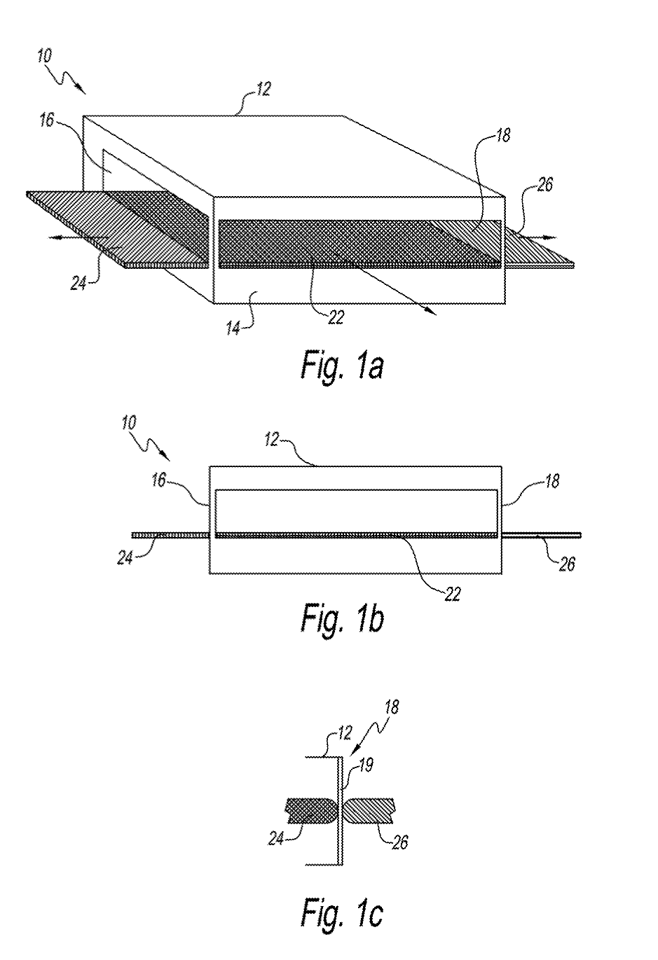

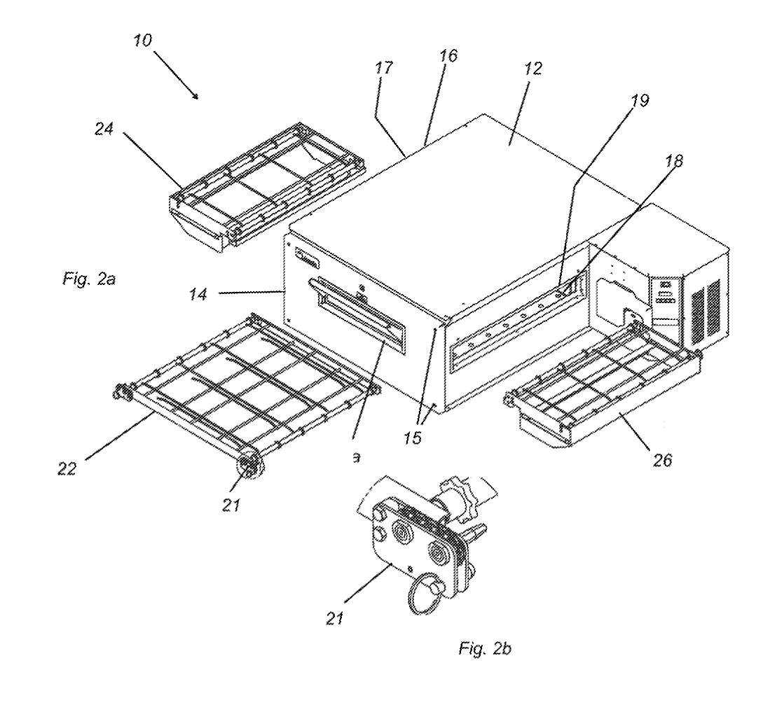

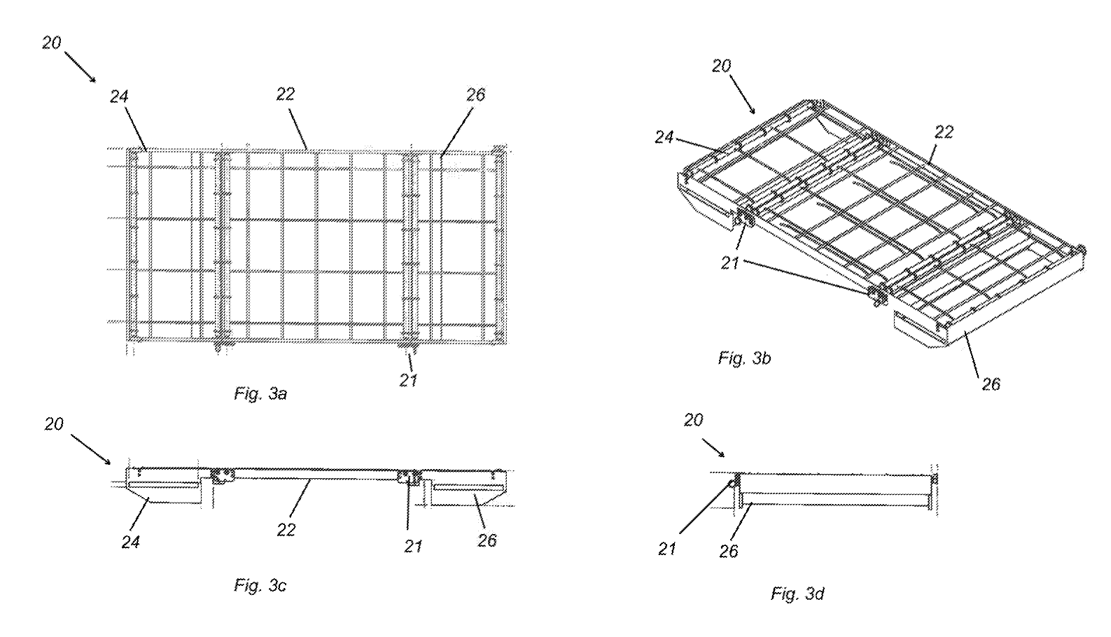

Referring to FIGS. 1a-3d, oven 10 of the present disclosure is shown. Oven 10 has a housing 12 that encloses a heating chamber (not shown), a front panel 14, and two side windows or openings 16 and 18. Openings 16 and 18 can also have doors 17 and 19 associated therewith, so close openings 16 and 18 respectively. To cook food products within the heating chamber, conveyor 20 carries the food through one of side openings 16, into the heating chamber. While within the heating chamber, the food is heated by one or more heating elements (not shown) or heated air supplied by one or more external heating elements, such as with an impinging air duct (not shown). Conveyor belt 20 then carries the food out through the other side opening 18.

Conveyor belt 20 can have two or more, preferably three or more sections. In the shown embodiments there are center section 22, first end section 24, and second end section 26. End sections 24 and 26 can be removably connected to center section 22. Thus, conveyor belt 20 eliminates the above-described problems with conventional ovens, in that end sections 24 and 26 can be easily removed by one person, and there is not a significant amount of clearance required to do so, aside from what is already provided.

Furthermore, front panel 14 is removable, and can have one or more fasteners 15 thereon, to allow for removal of panel 14. Center section 22 can then be taken out through the front of oven 10, as indicated by the directional arrow in FIG. 1a. This is a significant advantage over current devices, which again, require that the conveyor belt be moved out from the side of the oven. As described above, this requires a significant amount of valuable kitchen space and is labor intensive. Oven 10 of the present disclosure eliminates these concerns. In the example described above, current devices require one hundred thirty-seven inches of floor space. In the oven of the present disclosure, with a forty-inch oven and seventy-eight-inch conveyor, the space requirement is reduced to just slightly more than seventy-eight inches, a reduction of almost 43 percent.

Center section 22 needs to have a small enough length so that it can fit within the opening created when front panel 14 is removed. It can sit within a holder or carriage (not shown) within the heating chamber. Each of side sections 24 and 26 can be connected to or coupled with center section 22 while the latter is within the heating chamber. This connection can be achieved with a coupling device that transfers motion between conveyor sections, or by being connected with a pivot pins, and then pivoted into position.

Front panel 14 may also have a sliding chute or slot 19a, where food products can be added to center section 22 inside of the heating chamber. This can be helpful when a user wants to partially cook or heat the food product, and does not want it to pass along the entire length of the heating chamber. Slot 19a should be smaller than the length of front panel 14, and is thus not suited for removing center section 22.

Conveyor segments 22, 24, and 26 are connected mechanically via a drive transfer device 21 (FIG, 2b). Driver transfer device 21 can be a geared system, chain and sprocket, pulley mechanism, or any other suitable way to transfer motion from one of the segments to another. In the shown embodiment, device 21 uses gears and drive shafts to transfer motion from one of sections 22, 24, and 26 to an adjacent one. One of the gears is operably connected to a drive shaft of one of the conveyor sections 22, 24, and 26, and another of the gears is operably connected to an adjacent section. A chain can connect the two gears. When a drive shaft on one of the conveyor sections turns, it turns a first gear on device 21, and thus rotates the chain. The motion is transferred to the second gear and thus the drive shaft of an adjacent section. Device 21 may also have a quick release mechanism so that it can be removed without the use of tools. Other drive mechanisms are suitable for use in device 21, When the sections are connected in this way, advantageously, only one motor can be needed. For example, a motor (not shown) can drive the movement of center section 22. Since end sections 24 and 26 are connected to center section 22 via transfer device 21, the motor would drive movement of end sections 24 and 26 as well.

In the shown embodiment, device 21 is connected to conveyor sections 22, 24, and 26. However, device 21 may also be connected to housing 12. It may be somewhere within the heating chamber, or connected to a rear side of panel 14, and it may be in a fixed location. Sections 22, 24, and 26 could then be connected to device 21.

In an alternative embodiment, each segment could be provided with its own motion power, allowing for independent control of the motion of each of sections 22, 24, and 26. This may be advantageous in an application where, as one example, the user may want the first end section 24 to deliver food to center section 22, and then stop until it receives another food product. Similarly, the second end section 26 can be stopped until center section 22 delivers a product.

There can be small gaps between adjacent conveyor sections (FIG. 1c). This allows for side doors 17 and 19 to come down and seal off the heating chamber. The heating chamber can then be used for cooking methods such as steaming and/or microwaving.

The length of oven 10 can be any that is suitable for commercial cooking, such as forty to seventy inches, or any subranges therebetween. Conveyor belt 20 can also have any suitable length for commercial cooking. Conveyor belt 20 have a length of as small as oven 10 itself, up to twice the length of the oven, or any subranges therebetween. In one specific non-limiting embodiment, conveyor belt 20 can have a length of from sixty-six to one hundred six inches, or any subranges therebetween. Both shorter and longer conveyor ovens and conveyors belts can incorporate the segmented conveyor belt herein described. As discussed above, the length of center section 22 can correspond to that of the width of oven 10. The length of section 22 may also be slightly less, or even slightly more than the width of oven 10 and panel 14. In some embodiments, panel 14 may be designed so that it covers the entire width of oven 10, meaning that the entire front of oven 10 is removed with panel 14.

In an alternative embodiment, each of sections 22, 24, and 26 can be assembled outside of oven 10. The sections could also remain connected to one another, yet fold as conveyor 20 is removed. The doors 17 and 19 might not slide between segments, but might slide down to meet a segment that is part of the conveyor.

In the embodiments described above, each of sections 22, 24, and 26 has its own associated belt. In another alternative embodiment, there can be one conveyor belt that wraps around or otherwise connects each of sections 22, 24, and 26 to each other. The belt can be unthreaded or disconnected at one point and removed, so that a user can remove sections 22, 24, and 26.

While the present disclosure has been described with reference to one or more particular embodiments, it will be understood by those skilled in the art that various changes may be made and equivalents may be substituted for elements thereof without departing from the scope thereof. In addition, many modifications may be made to adapt a particular situation or material to the teachings of the disclosure without departing from the scope thereof. Therefore, it is intended that the disclosure not be limited to the particular embodiment(s) disclosed as the best mode contemplated for carrying out this disclosure.

What is claimed is:

1. A conveyor oven, comprising:
a housing defining a heating chamber;
a heating element or air duct within the heating chamber;
two openings, one each on opposing sides of the housing; and
a conveyor belt passing through each of the openings and the heating chamber,
wherein the conveyor belt comprises two or more sections that are removably connected to one another.

2. The oven of claim 1, wherein the housing further comprises a removable front panel, wherein one of the conveyor belt sections can be removed from and placed into the heating chamber when the front panel is removed.

3. The oven of claim 1, wherein adjacent sections are connected to one another with a coupling.

4. The oven of claim 3, wherein the coupling is a drive transfer device.

5. The oven of claim 4, further comprising a motor that controls motion of one of the sections, and the motion is transferred to adjacent sections via the drive transfer device.

6. The oven of claim 1, wherein each of the sections have a motor associated therewith, so that motion of each section can be controlled independently of other sections.

7. The oven of claim 1, wherein the two or more sections are a center section that is within the heating chamber, a first side section connected to the center section through one of the openings, and a second side section connected to the center section through the other of the openings.

8. The oven of claim 1, wherein each of the openings has a door associated therewith, to selectively open and close the associate opening.
